(19) United States
(12) Patent Application Publication
(10) Pub. No.: US 2013/0207032 A1
(43) Pub. Date: Aug. 15, 2013

(54) LITHIUM IRON SILICATE CATHODE MATERIAL AND ITS PRODUCTION

(71) Applicants: Serdar Tan, Antalya (TR); John Thomas, Uppsala (SE); Henrik Andersson, Helsingborg (SE); Torbjörn Gustafsson, Vange (SE)

(72) Inventors: Serdar Tan, Antalya (TR); John Thomas, Uppsala (SE); Henrik Andersson, Helsingborg (SE); Torbjörn Gustafsson, Vange (SE)

(73) Assignee: Höganas AB (publ), Höganas (SE)

(21) Appl. No.: 13/807,350

(22) PCT Filed: Jun. 29, 2011
(86) PCT No.: PCT/EP11/60932

§ 371 Date: Feb. 18, 2013

Related U.S. Application Data
(60) Provisional application No. 61/360,141, filed on Jun. 30, 2010.

(30) Foreign Application Priority Data
Jun. 30, 2010 (SE) 1000705-2

(51) Int. Cl. H01M 4/58

(52) U.S. Cl. CPC H01M 4/5825
USPC 252/182.1

(57) ABSTRACT

A method for producing a lithium insertion material including the steps of: providing an iron containing compound, a lithium containing compound and a silicate containing compound; providing a solvent; subjecting the compounds in said solvent to dissolution; obtaining precipitate; and filtering the obtained precipitate from the solution and subject the precipitate to washing and drying.

### TECHNICAL FIELD

The present invention relates to a method for producing a lithium insertion material for a battery, the material comprising iron, lithium and silicates.

### BACKGROUND

The further development of lithium ion batteries has long been a priority area for scientist and engineers since the battery technology is believed to be the most decisive feature in the large scale launch electric vehicles such as electric hybrids and similar. Lithium ion batteries have so far been the most promising type of batteries for such applications. A critical feature of such batteries is the cathode material and this area is the subject to intense research. Many types of compounds and modifications thereof have been suggested.

Lithium batteries today use a solid reductant as the anode and a solid oxidant as the cathode. On discharge, the anode supplies Li⁺ to the Li⁺ electrolyte and electrons to the external circuit. The cathode is typically a Li-ion host into which Li⁺ ions are inserted reversibly from the electrolyte as a guest species and charge-compensated by electrons from the external circuit.

The chemical reactions at the anode and cathode of a rechargeable lithium battery must be closely reversible. On charge, the removals of electrons from the cathode by an applied field releases Li⁺ ions into the electrolyte, and the addition of electrons from the anode attracts charge-compensating Li⁺ into the anode to restore the anode.

A common type of rechargeable Li-ion battery uses graphite as anode into which lithium is inserted and a layered or framework transition metal oxide as the cathode. Layered oxides using cobalt and/or nickel are however expensive and may degrade due to the incorporation of unwanted specimen from the electrolyte.

During the years various compounds have been suggested in order to provide an inexpensive cathode material, having a strong bonded three dimensional network and interconnected interstitial space for lithium insertion.

U.S. Pat. No. 5,910,382 to Goodenough et al, discloses transition metal-compounds having the ordered olivine structure or the rhombohedral NASICON (Na, Si, C, O, N) structure and based on the polyanion (PO)₄³⁻ as at least one constituent for use as cathode material, the material having the formula LiM(PO₄), wherein M may be Mn, Co, Ni or Fe. The material is prepared by calcining intimate mixtures of stoichiometric proportions of Li, Fe, PO₄³⁻ containing compounds followed by solid state reaction at 800° C. for 24 hours. Examples of the various compositions reported in this patent are prepared by solid state reductions at temperatures between 300° C. to 1200° C.

U.S. Pat. No. 6,514,640 to Armand et al describes a cathode material of the ordered or modified olivine structure having the formula;

LiₓM_{1-(d+t+q+r)}D_{d}TₜQ_{q}Rᵣ(XO₄)

Wherein M is a cation selected from the group of Fe, Mn, Co, Ti and Ni.

D is a metal having +2 oxidation state and selected from the group Mg²⁺, Ni²⁺, CO²⁺, Zn²⁺, Cu²⁺ and Ti²⁺

T is a metal having +3 oxidation state and selected from the group Al³⁺, Ti³⁺, Cr³⁺, Fe³⁺, Mn³⁺, Ga³⁺, Zn³⁺, and V³⁺

Q is a metal having +4 oxidation state and selected from the group Ti⁴⁺, Ge⁴⁺, Sn⁴⁺ and V⁴⁺

R is a metal having +5 oxidation state and selected from the group consisting of V⁵⁺, Nb⁵⁺ and Ta⁵⁺

X comprises Si, S, P, V or mixtures thereof,

0≦x≦1 and

0≦d, t, q, r≦1 where at least one of d, t, q, r is not 0.

The preparation of the various specimen according to U.S. Pat. No. 6,514,640 include solid state reactions at temperatures between 500 and 950° C., in certain cases followed by ion exchange in molten LiNO₃ at 300° C.

For cathode material containing lithium-iron-silicate to be used in Li-ion batteries a number of various specific compounds and methods, as well as starting materials, for their production have been suggested.

In WO 2008/107571 it is described a cathode material, and the process for forming such material, having the formula Li₂M^{II}₍₁₋ₓ₎M^{III}ₓSiO₄(OH)ₓ wherein 0≦x≦1, and M is Fe, Co, Mn, or Ni. The material is spherical in shape having a particle size between 400 to 600 nm.

The preparation of the compound is carried out in an aqueous solution of silicate, metal salt and lithium hydroxide. Further, when M is Fe, a reductant chosen from ascorbic acid or hydrazine is added. The reaction is performed at temperature between 80° C. and the boiling point of the solution, for 24 hours. Before starting the reaction argon gas is allowed to degas the solution, the reaction is taken place under reflux.

The x-ray diffraction patterns disclosed in the WO 2008/107571 clearly shows the presence of well crystallised materials of lithium iron silicates as evident from FIGS. 2-6 and lithium manganese silicates in FIG. 11 showing sharp and distinct diffraction peaks.

There is a need for more efficient materials for cathodes for batteries and more efficient methods for their production.

### SUMMARY OF THE INVENTION

It is an object of the present invention to provide efficient material for cathodes for batteries and to provide efficient methods for production of such materials.

It has now surprisingly been found that when utilising similar starting materials, e.g. LiOH, FeCl₂ and Na₂SiO₃, processed in a similar fashion, but for a considerably shorter time, at temperature above the boiling point of the solution at 1 atmosphere and at pressure above 1 atmosphere results in a lithium insertion material having similar or even improved electrochemical characteristics as compared with prior art. It should be noted that, unlike processes previously described, the presence of carbon during the process according to the present invention is not a prerequisite.

Depending on the process parameters the materials obtained may show a relatively high degree of crystallinity (mostly sharp XRD peaks), a relatively low degree of crystallinity (less sharp XRD peaks), or essentially no crystallinity (diffuse XRD pattern).

Further, the primary particle size of the material is below 200 nm or 100 nm and the specific surface area as measured by BET is above 40 or above 100 m²/gram. Another surprising finding is that the excellent electrochemical properties have been accomplished even without adding carbon film forming precursors such as citric acid. Without being bound to any specific scientific explanation this is believed to be due to the fine particle sizes of the material.

According to a first aspect of the invention, there is provided a method for producing a lithium insertion material comprising the steps of: providing an iron containing compound, a lithium containing compound and a silicate containing compound; providing a solvent; subjecting the compounds in said solvent to dissolution; subjecting the solution to t temperature above the boiling point of the solution at 1 atmosphere and at pressure above 1 atmosphere obtaining precipitate; and filtering the obtained precipitate from the solution and subject the precipitate to washing and drying.

The lithium insertion material may be used as a cathode in a battery.

The battery may be a lithium ion battery.

The method may further comprise a step of subjecting the obtained precipitate to elevated temperatures in an inert or slightly reducing atmosphere for a predefined period of time.

The iron containing compound may be selected from the group comprising iron chloride, iron sulphate, iron sulphite, iron nitrate, iron acetate, iron carbonate, iron oxalate, and iron formate, preferably selected from the group consisting of iron chloride and iron sulphate.

The lithium containing compound may be lithium chloride, lithium sulphate, lithium sulphite, lithium nitrate, lithium acetate, lithium oxalate, lithium formate, lithium hydroxide or lithium carbonate, preferably lithium hydroxide.

The silicate containing compound may be selected from the group comprising sodium silicate, potassium silicate and lithium silicate, preferably sodium silicate.

The compounds may be in solid state.

In one embodiment, the process does not include any carbon source.

The solvent may be selected from water or alcohols, preferably water.

The temperatures may be above 100° C. and up to 350° C. above 100 and up to −300° C., above 100 and up to 200° C., or between 150-250° C. The heating is preferably carried out during 1-10 hours or during 1-6 hours, most preferably during 2-5 hours,

The pressures may be above 1.013 and up to 165 bar, above 1.013 bar and up to 86 bar, above 1.013 bar and up to 15.5 bar or between 4.8 bar and 39.8 bar

According to a second aspect of the invention there is provided a lithium insertion material for a cathode in a battery having a composition according to the formula;

Li₍₂₋ₓ₎Fe^{II}_{y}Fe^{III}_{z}(SiO₄)_{å}

wherein 0<x2, and
4å=(2−x)+2y+3z.
å is preferably 1

The lithium insertion material may be characterised by being produced according to the method described in anyone of claims 1 to 10.

The lithium insertion material for a cathode in a battery may be characterised by being produced according to the method described in anyone of claims 1 to 10.

The lithium insertion material may be used as a cathode in a battery.

The battery may be a lithium ion battery.

According to a third aspect of the invention, there is provided a cathode for battery comprising a lithium insertion material being produced according to the method described in anyone of claims 1 to 10.

According to a fourth aspect of the invention, there is provided a lithium ion battery comprising a cathode according to claim 13.

Relevant parts of the explanations given above with regard to the method are also applicable to the lithium insertion material and the cathode. Reference is hereby made to these explanations.

### BRIEF DESCRIPTION OF THE DRAWINGS

FIG. 1 illustrates a diagram obtained from XRD.

FIG. 2 illustrates a SEM image.

FIG. 3 illustrates results from FTIR analysis.

### DETAILED DESCRIPTION AND EXAMPLES

The material obtained according to the method of the present invention may be described according to the following formula;

Li₍₂₋ₓ₎Fe^{II}_{y}Fe^{III}_{z}(SiO₄)_{å}

Wherein 0<x<2
4å=(2−x)+2y+3z

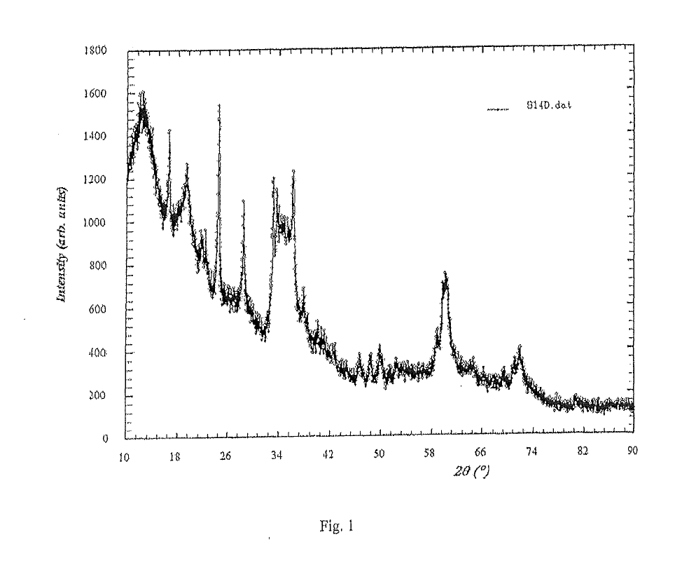

The following examples demonstrate the effect of the invention through variations in composition and process parameters. The ingredients used were of standard reagent grade, purchased from laboratory chemicals' suppliers. Reference to FIGS. 1-3 is made.

The general procedure was pre-mixing and grinding the solid ingredients prior to adding the solvent. The solvent was de-ionised water in all cases, in an amount of 56 ml. In all except one of the examples, the solvent was further deoxygenated by purging with argon gas prior to adding the solid ingredients. The material was subsequently allowed to dissolve and homogenize for a period of 40 minutes. Further processing was subsequently carried out at different times, temperatures and pressures for a preset period of time. For temperatures above the boiling point of the solution and, subsequently, pressures above one atmosphere, this reaction step was carried in an autoclave, under argon atmosphere. In these cases, the reaction vessel was placed into a pre-heated oven. When elevated temperatures were used, the solution was subsequently allowed to cool to room temperature before continuing to the following steps. Next, the precipitated product was filtered from the solution, and washed with de-ionized water, followed by washing with acetone. The obtained product was finally ground and subsequently dried at 100° C. under vacuum prior to further analysis.

Amounts and type of raw materials, and process parameters used according to table 1.

TABLE 1

| | Na₂SiO₃ | | FeCl₂ | Fe- | | | | |
|---|---|---|---|---|---|---|---|---|
| Ex No. | *5H₂O | SiO2 | *4H₂O | Acetate | LiOH | Temp. | Time | Remark |
| 1 | 2.128 g | | 2.490 g | | 0.484 g | 240° C. | 2 h | Auto- |
| | | | | | | | | clave |
| 3 | 1.939 g | | 2.723 g | | 0.438 g | 240° C. | 2 h | Auto- |
| | | | | | | | | clave |
| 4 | 2.267 g | | | 2.324 g | 0.512 g | 240° C. | 2 h | Auto- |
| | | | | | | | | clave |
| 5 | 2.128 g | | 2.490 g | | 0.484 g | 200° C. | 2 h | Auto- |
| | | | | | | | | clave |
| 6 | 2.128 g | | 2.490 g | | 0.484 g | 160° C. | 2 h | Auto- |
| | | | | | | | | clave |
| Comp 7 | 2.128 g | | 2.490 g | | 0.484 g | 25° C. | 2 h | Argon |
| | | | | | | | | purge |
| 8 | 2.128 g | | 2.490 g | | 0.484 g | 240° C. | 5 h | Auto- |
| | | | | | | | | clave |
| 9 | 2.128 g | | 2.490 g | | 0.484 g | 240° C. | 2 h | Auto- |
| | | | | | | | | clave |
| | | | | | | | | NoAr |
| | | | | | | | | purge |
| 10 comp | | 1.307 g | 1.990 g | | 0.960 g | | | Auto- |
| | | | | | | | | clave Ar |
| | | | | | | | | purge |

The obtained lithium insertion material was characterized by using various techniques.

The crystalline structure was determined by using X-ray diffraction (XRD, Cu—Kₐ radiation, 2θ: 10°-75°, 0.02°/step). BET (Brunauer, Emmet, Teller) analysis was used to determine the surface area of the obtained samples, and Scanning Electron Microscopy (FE-SEM) was used to obtain information on the particle size.

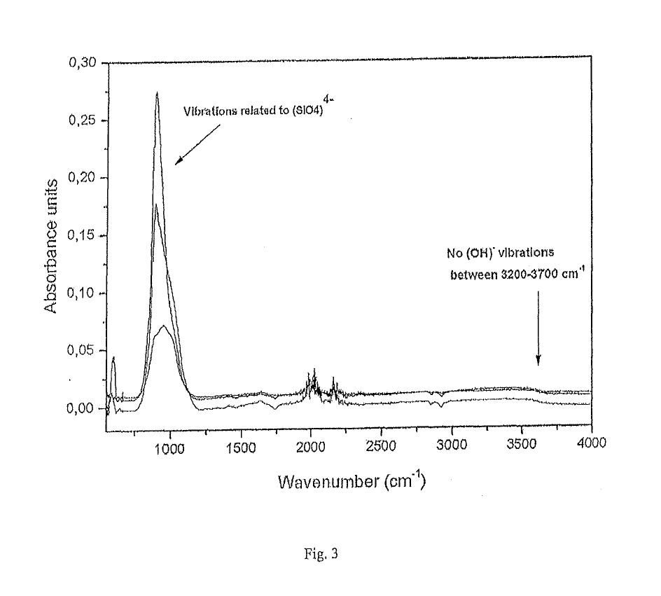

The chemical analysis as presented in FIG. 3 was obtained by Infrared Spectroscopy (FTIR).

The electrochemical testing of the lithium insertion material was carried out using the following procedure: The active material was mixed with 15 weight percent of a binder solution (added as a solution of 5% PVDF in NMP) and 10 weight percent of a conducting carbonaceous material, i.e. carbon black (Super P, from Evonics). The wet mixture was ball milled for 1 hour and then coated as slurry onto a 20 μm thick Al-foil. The thickness of the coating was 20-30 μm.

The coated foil was then mounted as a cathode half cell in a battery, where the anode was made from a thin foil of lithium metal. The electrolyte used was a 1 M LiPF₆ in a solvent mixture of EC (Ethylene Carbonate):DMC (Dimethyl Carbonate) in a ratio of 1:1 by volume. The electrodes were electrically insulated from one another by placing a porous separator (Solupor®, available from Lydell Corporation) between them.

The battery was cycled electrochemically between 4.0 and 1.5 Volts vs. Li/Li⁺ at a rate of C/20 (the battery is subjected to 20 hours of charging, and 20 hours of discharging). The temperature for the battery test was 60° C. in most cases. However, tests at room temperature were also made in some cases. The results were presented as mill Ampere hours/gram (mAh/g). See table 2.

TABLE 2

| | | | | | | Discharge | |
|---|---|---|---|---|---|---|---|
| | | | Primary | Initial | Discharge | cap after | |
| | | | particle | discharge | cap after | 10 cycles | Discharge |
| | | | size, | capacity | 5 cycles | C/20 60° C., | cap after |
| | | BET | Diameter | C/20 60° C. | C/20 60° C. | sample 1 | 20 cycles |
| No. | XRD | [m²/g] | [nm] | [mAh/g] | [mAh/g] | at RT | C/20 60° C., |
| 1 | a | 123 | <100 | 142 | 140 | 100 | |
| 3 | b | 140 | <100 | 163 | 146 | 132 | 99 |
| 4 | b | | | 145 | 126 | 127 | 100 |
| 5 | b | | | 175 | 149 | 160 | 211 |
| 6 | c | | <100 | 176 | 159 | 208 | 17 |
| 7 | c | 389 | <100 | 258 | 177 | 163 | 103 |
| 8 | a | 46 | <200 | 121 | 130 | 122 | 80 |
| 9 | a | 85 | | 150 | 139 | 128 | 110 |
| 10 | a | | | 10 | 20 | | |

a = relatively high degree of crystallinity shown according to XRD
b = relatively low degree of crystallinity shown according to XRD
c = essentially no crystallinty shown according to XRD

In a process comprising hydrothermal treatment followed by washing and drying without any further heat treatment, cathode materials having low particle size and high BET area may be obtained.

The maximum discharge capacity for a cathode based n Li—Fi-silicate is 172 mAh/g. Values above this threshold indicate that side reaction occurs which are detrimental to the cathodes. This is evident in nos 6 and 7. It is believed that no 5 will suffer similar effect after further cycling.

Thus, in order to obtain acceptable values for a cathode material obtained through a hydrothermal processing of sodium meta silicate, LiOH and/or Li₂CO₃ and FeCl₂ the precursors shall be dissolved in water and further subjected to elevated pressures at temperatures up to 300° C. for a period of time of 10 minutes to 5 hours depending of the amount of material to be processed. Further it has also been noticed that the addition of organic carbon containing compounds in order to act as reduction agent or carbon film forming precursor is not necessary in contrast to what has been previously believed.

The diagram in FIG. 1 shows result from XRD of sample 1.

As can be seen from FIG. 1 the XRD peaks are in most cases sharp, but also some less sharp peaks are registered.

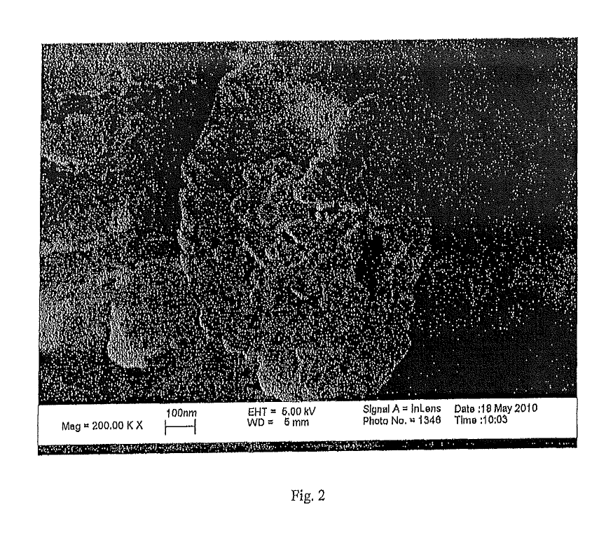

The SEM image in FIG. 2 shows a particle of sample 1 having an agglomerated structure with primary particles of less than 100 nm.

Sample 1 has also been subjected to a FTIR analysis, the resulting traces are shown in FIG. 3.

The FTIR analysis reveals that no hydroxide-groups can be identified.

The following conclusions can be drawn from the above experiments:
Carbon-free Li—Fe—Si based active cathode material is produced in a one-step process at a temperature below 300° C. fairly cheap raw materials without any reducing agent,
Initial discharge capacity of the synthesized material is higher than 140 mAh/g at 60° C.
The material has quite stable electrochemical activity at room temperature with discharge capacity ca. 90 mAh/g,
The synthesized powders has particle size of less than 200 nm, for example less than 100 nm, and BET surface area higher than 40, and for the majority of the results higher than 100 m²/g,
The use of Na₂SiO₃, as Si source, is beneficial in order to get cathode material with high electrochemical activity.

1. A method for producing a lithium insertion material comprising the steps of:
providing an iron containing compound, a lithium containing compound and a silicate containing compound
providing a solvent
subjecting the compounds in said solvent to dissolution in order to obtain a solution
subjecting the solution to temperature above the boiling point of the solution at 1 atmosphere and at pressure above 1 atmosphere in order to obtain a precipitate, and
filtering the obtained precipitate from the solution and subjecting the precipitate to washing and drying.

2. The method according to claim 1 wherein the iron containing compound is selected from the group comprising iron chloride, iron sulphate, iron sulphite, iron nitrate, iron acetate, iron carbonate, iron oxalate, and iron formate.

3. The method according to claim 1, wherein the lithium containing compound is lithium chloride, lithium sulphate, lithium sulphite, lithium nitrate, lithium acetate, lithium oxalate, lithium formate, lithium hydroxide or lithium carbonate.

4. The method according to claim 1, wherein the silicate containing compound is selected from the group comprising sodium silicate, potassium silicate and lithium silicate.

5. The method according to claim 1, wherein the solvent is selected from water or alcohols.

6. The method according to claim 2, wherein the temperatures are above 100° C. and up to 350° C.

7. The method according to claim 6, wherein the temperatures is between 150° C. and 250°.

8. The method according to claim 2, wherein the pressures are above 1.013 and up to 165 bar.

9. The method according to claim 8, wherein the pressures are between 4.8-39.8 bar.

10. A lithium insertion material for a cathode in a battery having a composition according to the formula:
Li_{(2-X)}Fe^{II}_{y}Fe^{III}_{z}(SiO₄)_{å}
wherein 0<x<2, and
4å=(2−x)+2y+3z.

11. A lithium insertion material for a cathode in a battery, the lithium insertion material being produced according to the method described in claim 1.

12. A cathode for battery comprising a lithium insertion material being produced according to the method described in claim 1.

13. A lithium ion battery comprising a cathode according to claim 12.

14. The method according to claim 2, wherein the iron containing compound is selected from the group consisting of iron chloride and iron sulphate.

15. The method according to claim 3, wherein the lithium containing compound is lithium hydroxide.

16. The method according to claim 4, wherein the silicate containing compound is sodium silicate.

17. The method according to claim 5, wherein the solvent is water.
